(19) United States
(12) Patent Application Publication
(10) Pub. No.: US 2006/0135216 A1
(43) Pub. Date: Jun. 22, 2006

(54) Containing structure that integrates a rear-view driving mirror and telephone apparatus which allows communication and visualization of images with a remote control device of the cellular phone of the type with bluetooth technology

(75) Inventors: Andrea Collavo, Lentiai - Belluno (IT); Bettino Perissinotto, San Dona di Piave - Venezia (IT)

Correspondence Address: John S. Egbert;Egbert Law Offices, 412 Main Street, 7th Floor, Houston, TX, 77002, US

(73) Assignee: PLASTAL SPA, Pordenone (IT)

(21) Appl. No.: 11/271,485

(22) Filed: Nov. 10, 2005

(30) Foreign Application Priority Data
Nov. 12, 2004 (IT) TV2004000060

(51) Int. Cl. H04M 1/00

(52) U.S. Cl. 455/569.2; 455/41.2

(57) ABSTRACT

The present invention includes a containing structure that integrates a rear-view driving mirror and a multifunction device to receive and send information also by means of a display or a monitor with a remote control device of the cellular phone of the type with bluetooth technology. The invention concerns a containing structure which, generically, with a simple touch to the structure that integrates the mirror, even in reduced visibility conditions, as is the case while driving at night, allows the activation or deactivation of the communication function, also by visualization of images, without removing one's gaze from the road, therefore maintaining suitable attention.

They are first generation systems which are usually integrated in the dashboard of the motor vehicle in a central position coinciding mainly with the center axle of the vehicle above the central tunnel. Equipped with an on-board monitor of generous size, they show all the selected functions operating on an alphanumeric keyboard and other keys or small buttons.

These solutions, which provide the use of an integrated telephone in the vehicle, require the manual insertion of the SIM, or its duplicate, into the vehicular telephone.

More evolved systems can also provide a remote control which can sometimes be integrated in the steering-wheel. These systems fall within the typology of equipment that offered to reduce, as far as possible, the problem of driver distraction, even momentary, due to the search for function keys present on phone equipment, by giving the possibility of using of a remote control with base functions.

In the research for the safest positions for containing devices of the functions of the cellular phone, some have sensed that the fundamental requisite could be that of not lowering one's gaze but merely turning it sideways, and even raising it a little, yet always remaining facing the direction of the road. A conclusion was consequently reached, that in any case the sideways movement, for example towards the internal rear-view driving mirror, is generally faster and always allows one to be aware of what is happening beyond the windscreen panel.

In this way, US2002/0004416 (Baratono), aimed to realize a system, so-called hands-free, that combines a mobile phone or a telephone unit with a rear-view driving mirror for automobiles. More particularly, a housing is provided that incorporates, in the part directed towards the windscreen panel, a rear-view driving mirror, on the inside of which a cellular phone can be introduced, which is removable, to receive and make telephone calls. Said housing is provided with an electronic circuit to which the mobile phone must be physically connected by means of manual operation. The mirror integrates moreover: a loudspeaker, microphone and keyboard to render the telephone functions accessible to the driver.

GB2356312 (Abbas), describes a solution somewhat similar to the previous one. In more detail, one can affirm that the latter differs from the former by providing a different positioning of the keyboard, which in this case is obtained in a linear sequence along the lower side of the mirror. Alongside it, there is a display positioned lengthwise, to show information always in a linear way.

### PRIOR ART CLOSEST TO THE INVENTION

ITTV2002A000072 (Collavo et al), describes a containing device with remote control of the cellular phone that is connected automatically to the latter (in a range of about 10 m). In this way, the driver is not required to handle his own telephone which can remain housed where it is (pocket, bag, and so forth). Said containing device consists of a container that preferably integrates also the rear-view driving mirror. In said container, on the side facing the occupants of the vehicle, the following are provided:

a microphone

at least one ON/OFF/Voice Activator switch

a display (optional) to visualize the phone number (incoming or outgoing)

and a base keyboard

a loudspeaker (optional)

a comprehensive electronic circuit of a bluetooth wireless reception/transmission system able to communicate with a cellular phone equipped with the same wireless technology.

U.S. Pat. No. 6,356,376 (Tonar et al), differently to the previous one, suggests a rear-view driving mirror which is provided with a display to visualize information, e.g. the temperature or the compass degrees, in such a way that the image crosses the rear-view driving mirror until appearing on its facade.

U.S. Pat. No. 6,412,959 (Tseng), proposes a rear-view driving mirror device which has a monitor or a visualizer, which mirror is positioned frontally with respect to the housing that is fixed onto a vehicle. A visualizer is positioned in the housing and behind the mirror element and it can be viewed through the mirror element when the visualizer is activated. An on-board circuit is joined to the visualizer and to an antenna to receive signals from the other facilities. The housing can have one or more extensions.

US2002/0141086 (Lang et al.) describes a lateral rear-view driving mirror which provides equipment for reproducing images, e.g. a monitor. The Monitor is connected to a video camera, which captures a field of vision at the side of or behind the vehicle.

US2002/0011927 (Lang et al.) also proposes a monitor combined with a lateral rear-view driving mirror, but differently to the previous, where at least one monitor, contained in the housing of the rear-view driving mirror, is visible through the reflecting surface of the mirror. U.S. Pat. No. 5,689,241 (Clarke et al.) describes a device for detecting the degree of attention of the driver. Said device could be placed around the rear-view driving mirror or on the dashboard.

### BRIEF SUMMARY OF THE INVENTION

The object of this invention consists of the containing structure that integrates a rear-view driving mirror and a multifunction device to receive and send information also by means of a display or a monitor with a remote control device of the cellular phone of the type with bluetooth technology, which provides:

at least two vertical keys of generous size and visible in the dark, placed on the right-hand and left-hand side of the rear-view mirror respectively, with the simple functions ON and OFF, or alternatively both aligned one above the other on one of said two sides;

a microphone obtained along the profile of the rear-view driving mirror structure protruding at the driver side and almost directed perpendicularly to the mouth of the driver;

lighting devices able to show the status of the multifunction apparatus;

buttons with panic function laterally equipped with a device against undesired activation;

vents for ventilation as well as a connector for the power supply, the audio function and other, obtained on the underside of the containing structure with respect to that displaying the rear-view driving mirror;

an electronic card housed lengthwise inside the containing structure;

an alphanumeric display obtained on the driver side;

a monitor obtained on the driver side protruding from the lower side of the containing device;

an integrated monitor in the area corresponding to that of the reflecting surface;

a sleep detection device, which is obtained along the upper profile of the containing structure on the driver side.

Aims

This concerns a containing structure which, generically, with a simple touch to the structure that integrates the mirror, even in reduced visibility conditions, as is the case while driving at night, allows the activation or deactivation of the communication function, also by means of visualization of images, without removing one's gaze from the road, therefore maintaining suitable attention.

A first aim is the identification of an easier and more functional positioning of the on/off keys, which can be easily identified by touch also in the dark.

A second aim is the identification of the best position of the microphone as close to the driver as to qualitatively improve the audio which is not disturbed by the airflows along the window panels of the vehicle.

A third aim is the identification of the best position of the “panic” function keys on the driver side of the containing structure, in such a way to make them easily identifiable and prevent their accidental activation by means of lateral bars, which, as they protrude out of the containing structure at least as much as the protruding portion of the respective activation key, delimit the two lateral extremities.

A fourth aim is the identification of the best position of the sleep detection device, which in this case is much nearer the gaze of the driver and is obtained along the upper profile, on the driver side corner of the containing structure. In this way it observes each small variation with regard to set parameters including the movements of at least one eyelid and/or scanning of the eye to transmit it to a data processing device able to emit at least one alarm signal of the acoustic and/or visual type.

A fifth aim is the identification of the best position of the monitor/display, which is always placed on the driver side of the containing structure and along the lower profile, in such a way as to be easily visible.

The position of the keys as described above allows one to maintain a greater degree of attention during driving.

Finally, also the position of the connector, on the back of the containing structure very easily allows a fast connection with the power supply of the devices conventionally present on board.

### BRIEF DESCRIPTION OF THE SEVERAL VIEWS OF THE DRAWINGS

FIG. 1 is a perspective view of the containing structure.

FIG. 2 is a perspective view with a hand activating the ON key and an arrow for movement.

FIG. 3 is another perspective view with a hand activating the OFF key and an arrow for movement.

FIG. 4 is a front elevation view of the containing structure.

FIG. 5 is a top plan view of the containing structure with the dash pattern dimension of the electronic card housed inside the mirror.

FIG. 6 is a side elevation view with an arrow on the movement of the glare proof lever, provided with a fixing to the support, a glare proof mirror inclination lever, and a microphone inclined towards the mouth of the driver.

FIG. 7 is a 3D rear perspective view of the containing structure, the connector towards the vehicle for the power supply, audio and vents for airing and ventilation.

FIG. 8 is a front elevation view of the containing structure, which is the object of this invention, with “panic” keys or other functions provided by accidental pressure prevention devices along the lower profile on the driver side adjacent to the microphone.

FIG. 9 is a front elevation view of the containing structure, which is the object of this invention, with, along the lower profile, a lengthwise protruding portion suitable to contain an alphanumeric display.

FIG. 10 is another front elevation view of the containing structure, which is the object of this invention, with, along the lower profile, a lengthwise protruding portion suitable to contain a monitor and in the part immediately above, along the lower profile of the mirror delimitation, an alphanumeric keyboard with function keys.

FIG. 11 is another front perspective view of the containing structure, which is the object of this invention, which integrates a monitor on the driver side of the reflecting surface.

FIG. 12 is a front perspective view of the containing structure, which is the object of this invention, which provides, along the lower profile, a lengthwise protruding portion suitable to contain an alphanumeric display and in the portion immediately above an alphanumeric keyboard with function controls.

FIG. 13 is a front perspective view of the containing structure, which is the object of this invention, which provides along the upper edge of the driver side a video camera also with a biometric function.

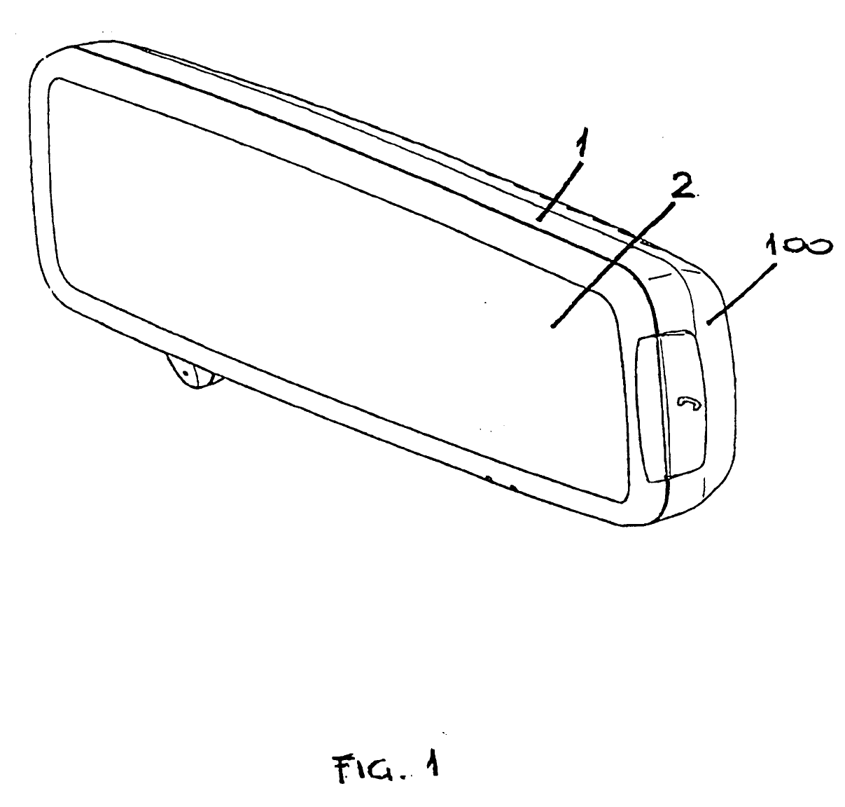

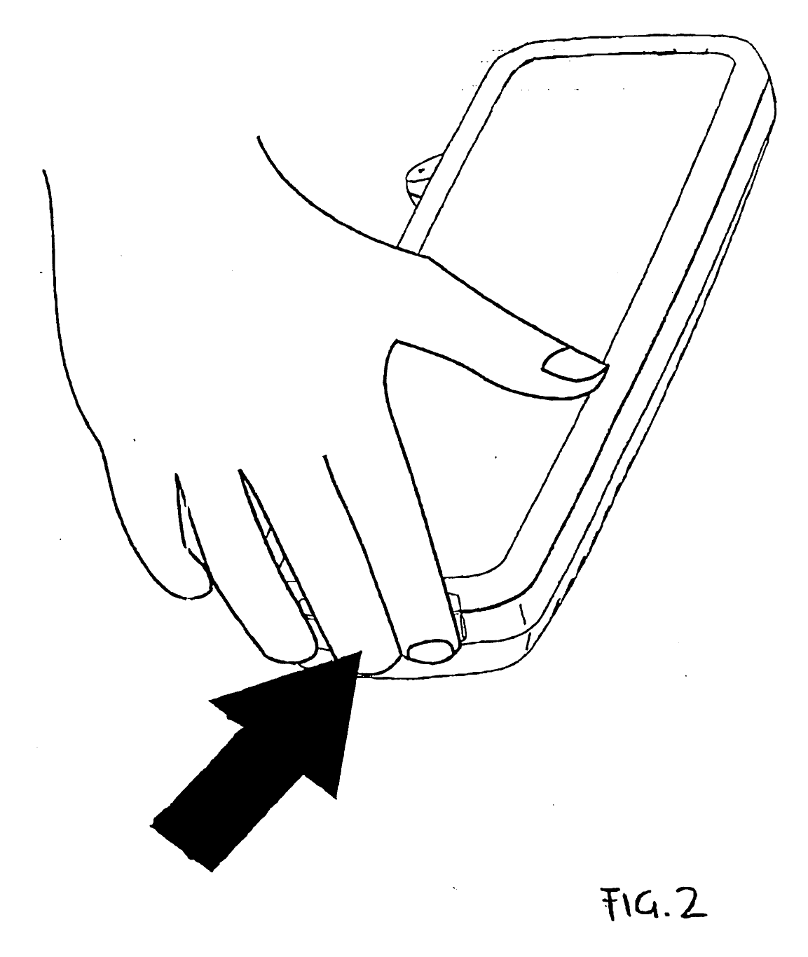

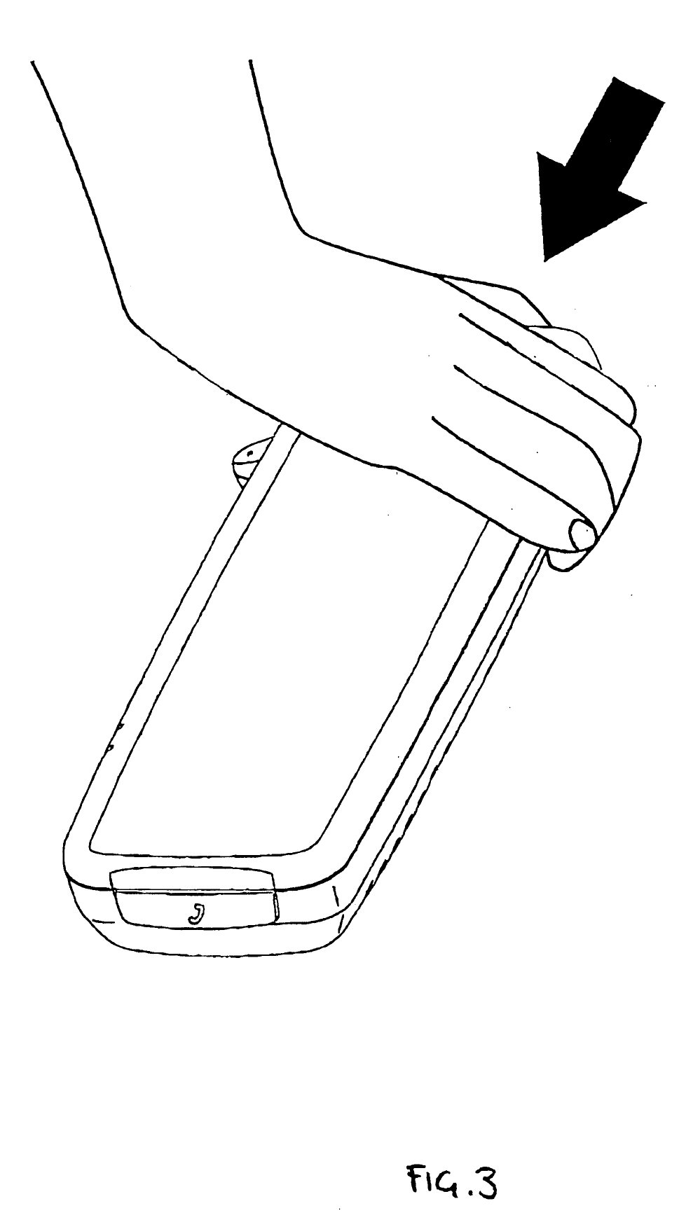

### DETAILED DESCRIPTION OF THE INVENTION

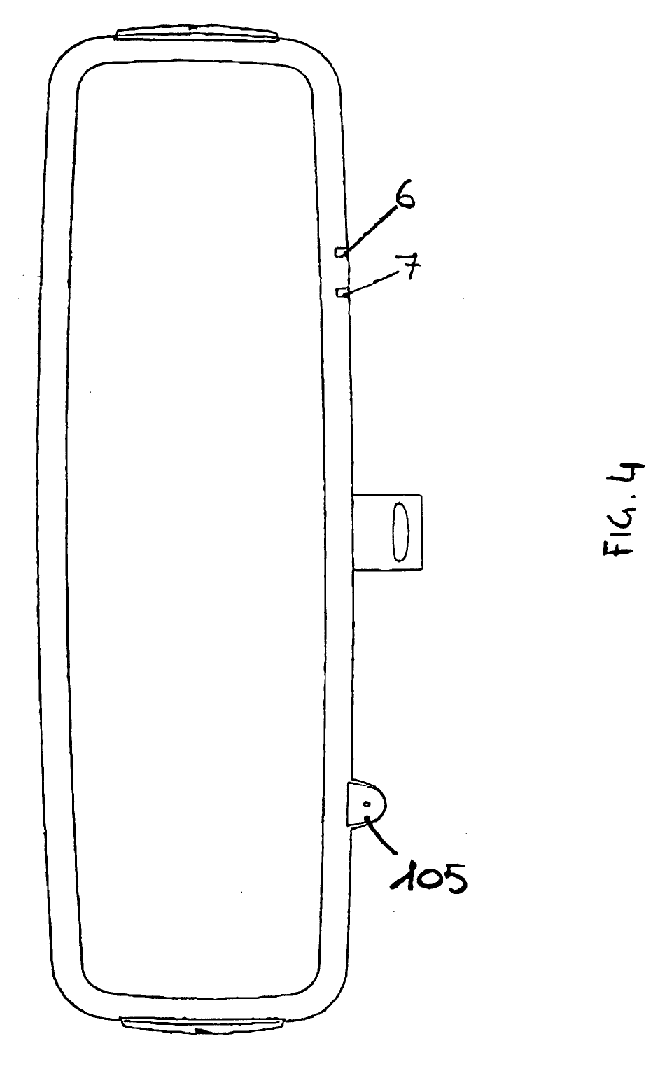

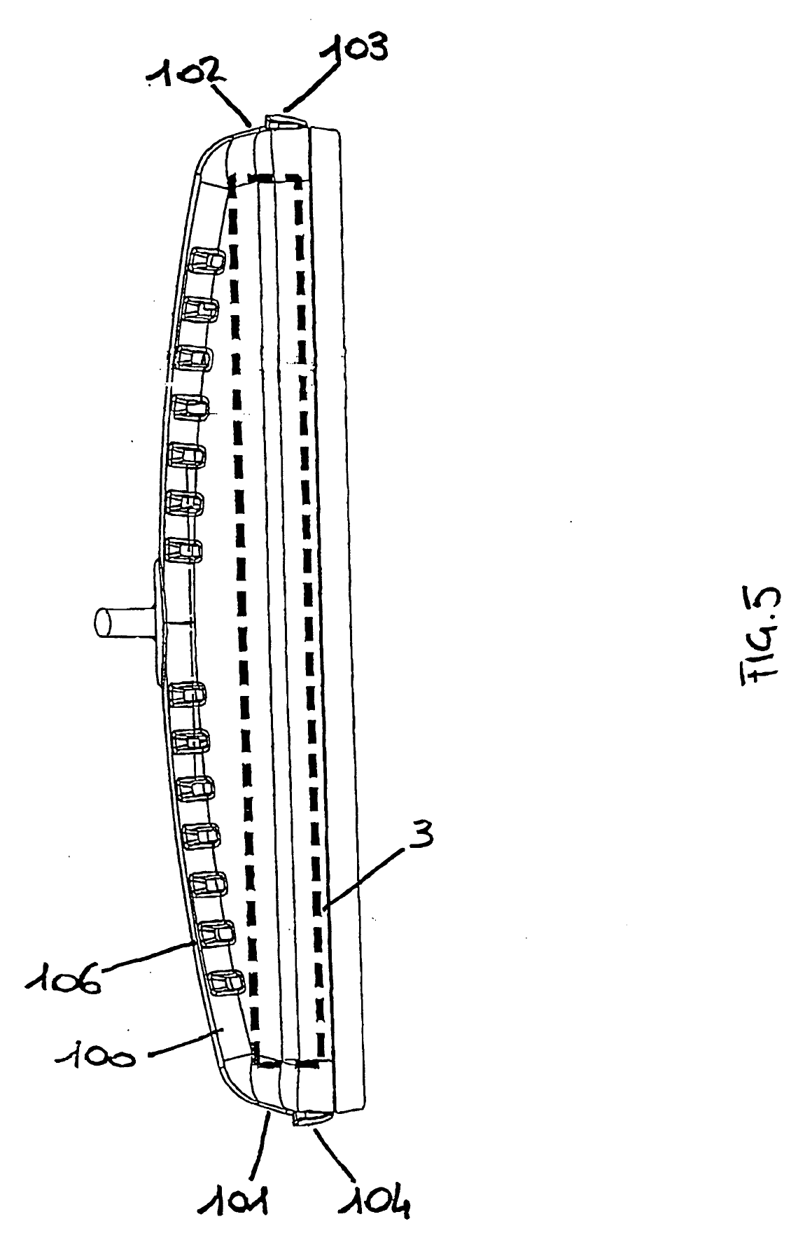

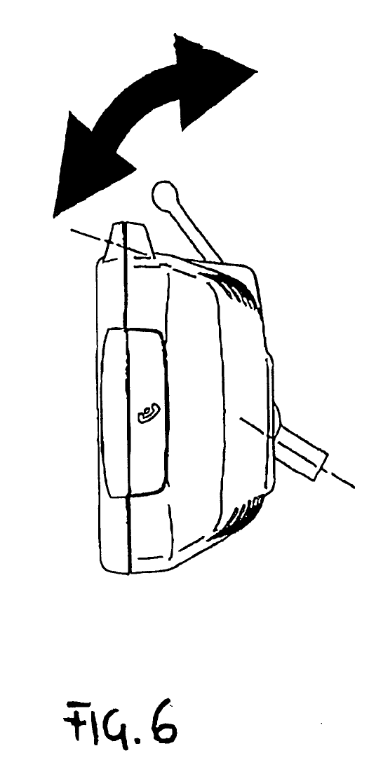

The containing structure 1 that integrates a driving mirror 2 and a multifunction apparatus with an electronic card 3 to receive and send information also by means of visualization of the same through a display or a monitor, with a remote control device of the cellular phone of the type with bluetooth technology, consists of a container, essentially box-like typically in plastic material, to which, on the front side, a reflecting surface that constitutes the driving mirror 2 is joined or obtained. The containing structure provides at the back part a protuberance 100 that constitutes the housing seat of at least one multifunction apparatus with an electronic card 3 placed lengthwise and vertically. Along the sides 101, 102 of the containing structure 1 two big buttons are provided, 103 and 104 respectively of 38 mm by 10 mm which are able to be activated with the function OFF/ON even without removing one's gaze from the road as they are very big and one is placed on the right-hand side (on) and the other on the left (off). The position of the keys 103 and 104 and the microphone 105 are ergonomically optimal. In particular the microphone 105 is placed close to mouth of the driver and perpendicular to it. The quality of the audio is better because there is no disturbance from the airflows along the window panels or the posts. The microphone 105 is therefore positioned on left-hand side of the containing structure 1 that integrates a rear-view driving mirror 2 (see FIG. 4) and is obtained providing the containing structure 1 with a rounded protruding portioned shape, along the profile of said containing structure 1 that is open on the driver side.

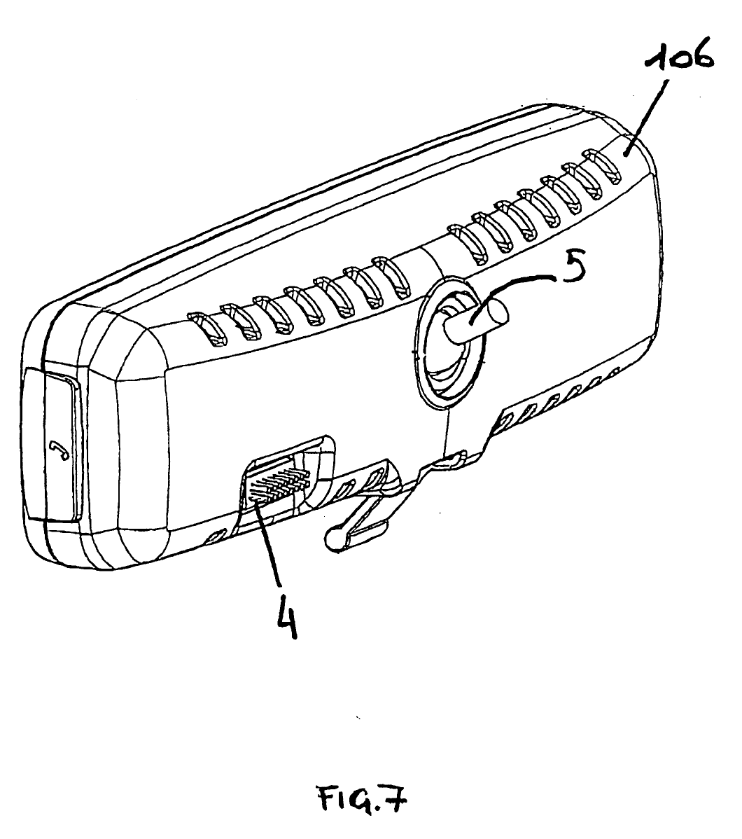

The containing structure 1 (see FIG. 7) is also provided at the back with a series of vents 106 which allow the airing of the electronics housed in it. A connector 4 enclosed in the back of the protuberance 100 is provided and positioned on the lower part to allow convenient connection to the power supply and transmission of possible data/information, and other. Centrally, a swivel support 5 similar to an integrated pin allows the spaced support of the containing structure 1 from the windscreen panel (not shown) of the vehicle.

On the front side of the containing structure 1 (see FIG. 4), integrated along the lower profile of the frame that delimits the rear-view driving mirror 2, LED 6 and 7 are provided, which show the operative status of the multifunction apparatus.

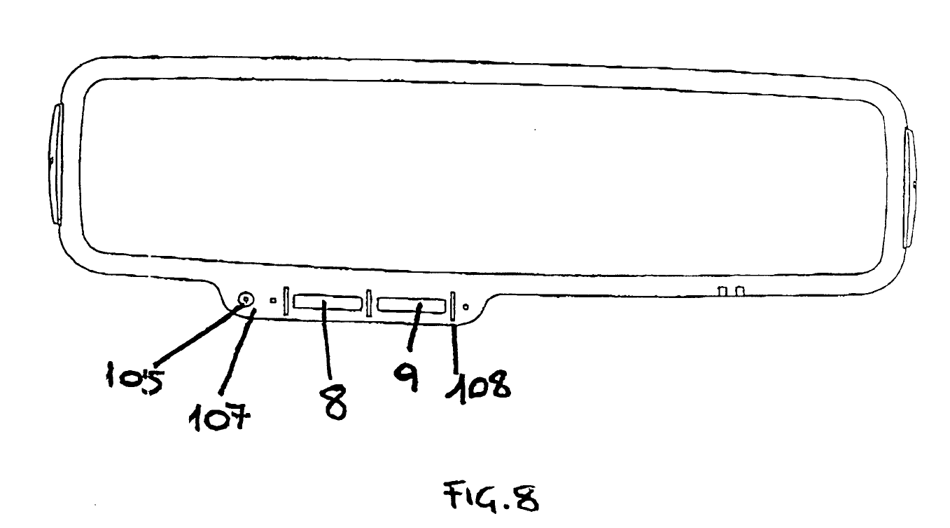

In one variant of the containing structure 1 (see FIG. 8), a shaped protruding portion 107 is provided on the lower left-hand side of the frame that delimits the rear-view driving mirror 2, which projects lengthwise and integrates the microphone 105 and two adjacent keys, 8 and 9, which can have multiple operating functions, for example “panic”. In order to avoid accidental pressing, said keys 8 and 9 are laterally protected by vertical bars 108 with respect to the insertion direction of said keys 8 and 9, said vertical bars protruding at a distance at least equal to that of keys 8 and 9.

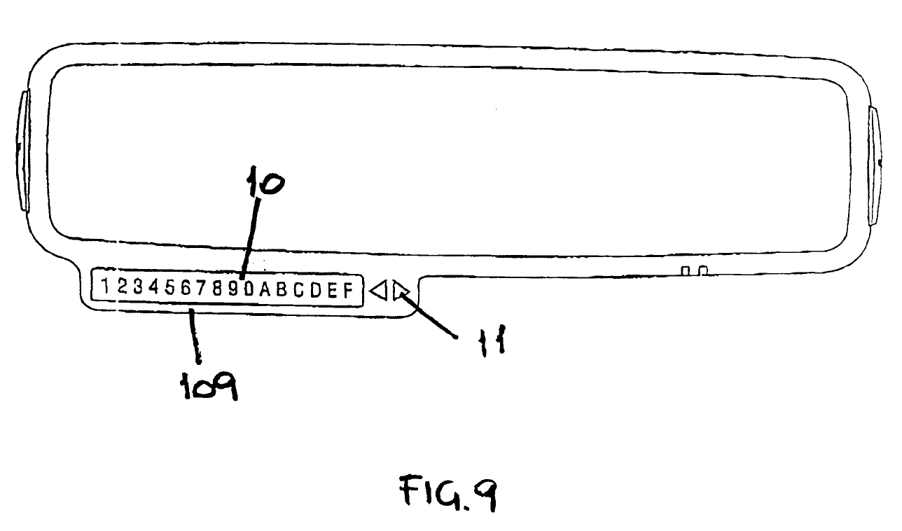

In the FIG. 9 variant, the containing structure 1 provides, on lower left-hand side of the frame that delimits the rear-view driving mirror 2, a shaped protruding portion 109 which is projected lengthwise and which integrates an alphanumeric display 10 with alongside related symbolizing 11.

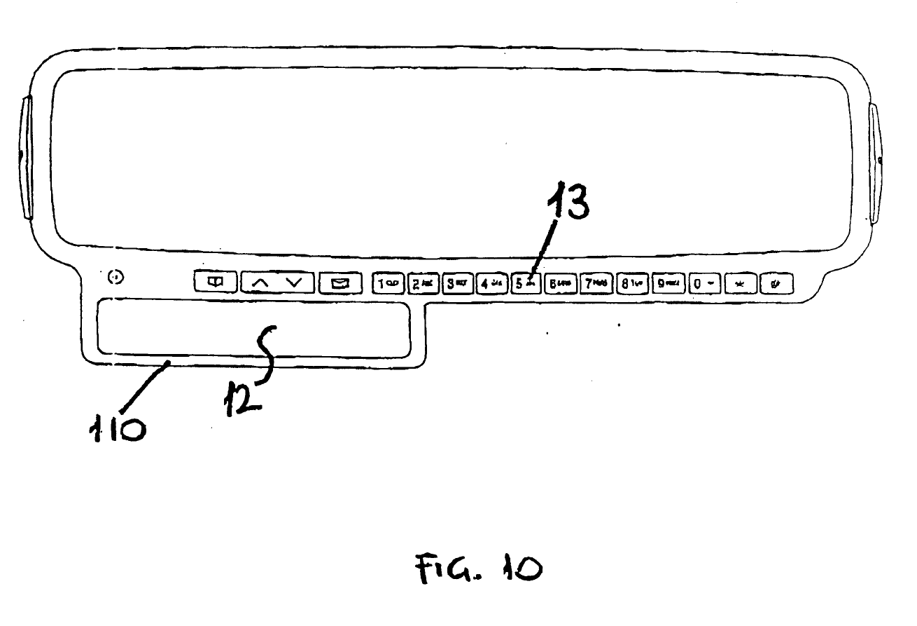

The prospected solution in FIG. 10 continues the shape of the containing structure 1 provided in FIG. 9. More particularly, along the lower driver side edge, a shaped protruding portion 110 is provided which projects lengthwise along and below the frame that integrates the rear-view driving mirror 2. Said shaped protruding portion 1 10 integrates a monitor 12 which is also projected lengthwise and which allows the visualization of names, numbers, SMS, MMS, e-mails and different images e.g. those originating from a so-called rear-view camera. Along the lower border that constitutes part of the frame that delimits the rear-view driving mirror 2 an integrated alphanumeric keyboard 13 is provided and with relative function/option keys placed in such a way as to result aligned.

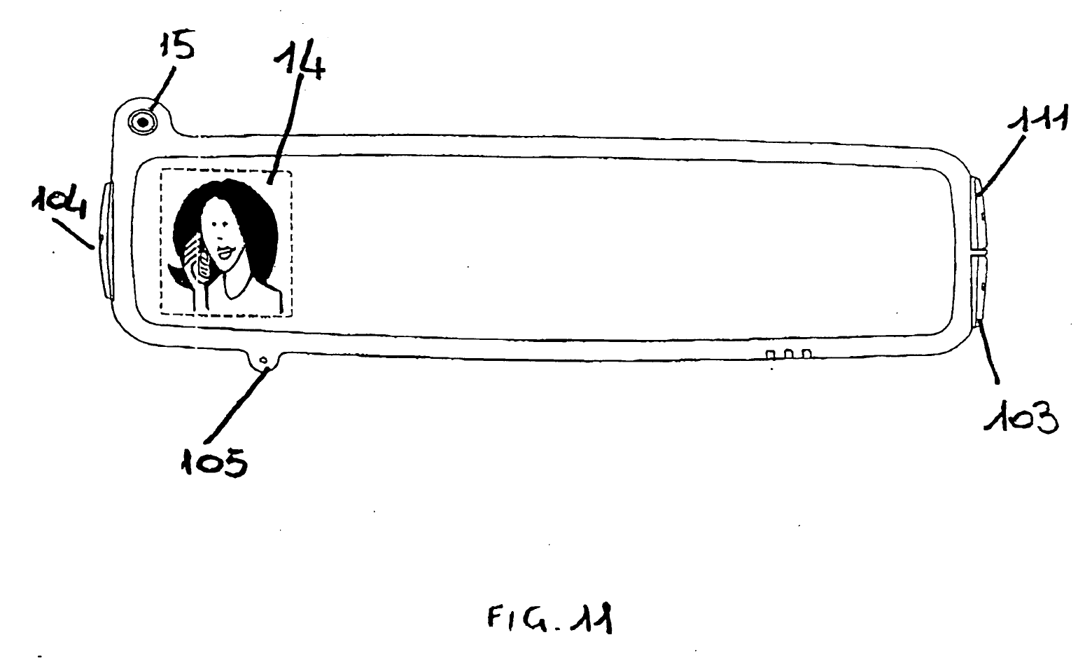

In FIG. 11, a containing structure 1 is described which integrates in an area, preferably the driver side of the rear-view driving mirror 2, a microphone 105 and a monitor/display 14. Also in this case, on the right-hand and left-hand sides respectively, generously sized keys 103 and 104 and 111 are provided. In this case, on the right-hand side, above key 103 that has the function to activate the audio, a second vertically aligned key 111 of the same size as the one below is provided, whose aim is to allow the activation of the video function for video calls. For such purpose, a video camera 15 is provided, which is placed on the upper corner of the containing structure 1, driver side, and is integrated inside a projection protruding from the upper profile of the frame that delimits the rear-view driving mirror 2.

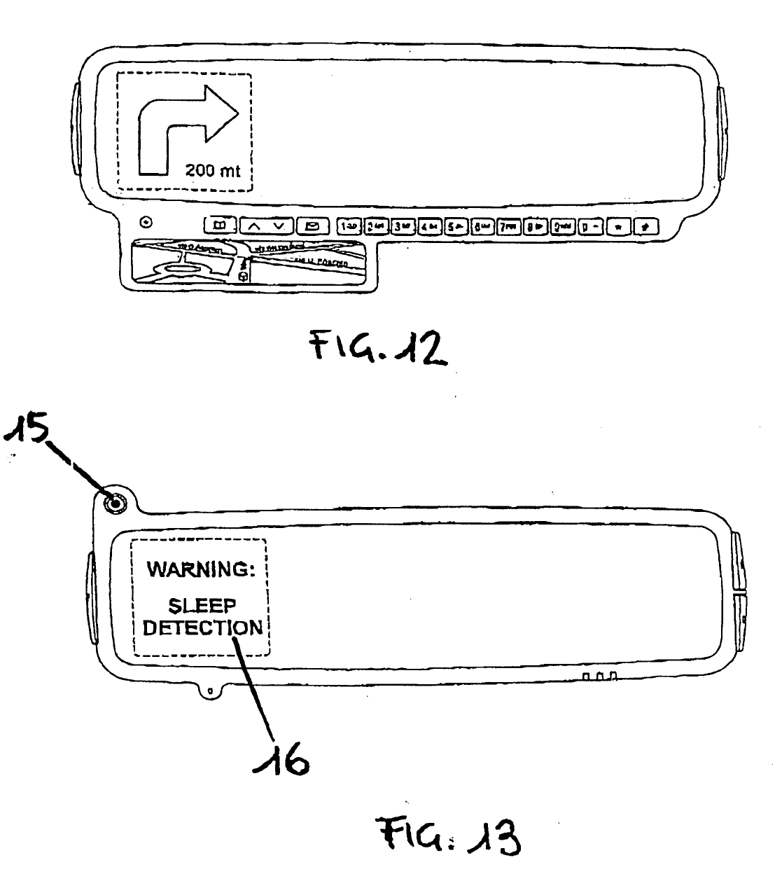

An evolution of the containing structure 1 shown in FIG. 10 consists of the solution illustrated in FIG. 12 in which, in addition to the monitor 12 integrated lengthwise into the projecting portion 110, a monitor/display 14 integrated in the rear-view driving mirror is provided.

Finally, FIG. 13 shows a containing structure 1 that provides a “sleep detection” function. In more detail, it appears similar to the solution shown in FIG. 11, but where, in place of the monitor 14, a display 16 is provided, which has the function to show the relative information. More particularly, the video camera 15, in this case, is provided with functions of the type suitable to carry out the scanning of the eye by means of facial biometrical data processing. A program of processing the data acquired by the video camera has the function to compare data previously archived during usual driving conditions with that scanned, in such a way that if not falling within the conventional parameters it constitutes the alert threshold. In this hypothesis, the display 16, by means of the emission of a bright signal/writing, informs the driver also by emitting a sound signal if necessary. One possible function of the video camera 15, of the antitheft type, is also to scan the facial biometry of the face in order to authenticate the presence on board of the person authorized to the start the vehicle.

University tests confirmed that this interface used by the driver (big buttons on the right+left 103, 104 and the LED 6, 7 of the indication of the status of the system), considerably reduces driving distractions connected to using the cellular phone in so far as they are not superimposed onto the function/direction of driving and at the same time they are not too remote like the traditional buttons on a dashboard or in the central tunnel (the driver is obliged to remove his eyes from the road for a few moments).

The automatic bluetooth connection with intuitive and ergonomic “anti-error” ON button, speech call and anti-error OFF button is provided, which optimizes the system with regards to “driving safety”, reducing distractions connected to using the cellular phone.

The following versions are also provided:

display to show/scroll the address book

monitor+keyboard to “remote” ones own cellular phone (obviously the use of the keyboard has to be carried out when the vehicle is stopped)

SOS version with “panic” buttons

version with videocalling and integrated monitor in the mirror

navigator version with simplified directions

sleep detection version: the lens scans the eye and launches an alarm if the driver is falling asleep.

We claim:

1. Containing structure that integrates a rear-view driving mirror and a multifunction apparatus to receive and send information by visualization thereof through a display or a monitor, with a remote control device of a cellular phone of a type with bluetooth technology, said containing structure comprising:
a comprehensive electronic unit of a transmission/reception system able to communicate with a cellular phone provided with communication system with bluetooth technology;
a microphone;
at least one ON/OFF/Voice Activator switch; and, if necessary, at least one item of a group consisting of:
a base keyboard, partly realized with a touch screen;
at least one loudspeaker or the piloting of external loudspeakers,;
a monitor and/or a display;
an input for video signals;
a GPS unit with relative antenna, interfaced with a cartographic navigation system in real time;
video camera (UMTS, WiFi) for videocalling; and
a sleep detection unit, having at least two large buttons, placed along sides thereof with a function OFF/ON visible in dark conditions.

2. Containing structure that integrates a rear-view driving mirror and an apparatus according to claim 1, wherein said microphone is placed close to a mouth of a driver and perpendicular thereto and positioned on a rounded protruding portion, along a lower lengthwise profile thereof, defining a frame of a driving mirror.

3. Containing structure that integrates a rear-view driving mirror and an apparatus according to claim 1, further comprising:
a video camera placed on an upper corner of a driver side thereof and integrated inside a projection protruding from the upper profile of the frame defining the rear-view driving mirror.

4. Containing structure that integrates a rear-view driving mirror and an apparatus according to claim 1, further comprising:
a shaped protruding portion on a lower left-hand side of a frame defining the rear-view driving mirror, being projected lengthwise which integrates said microphone and two adjacent keys with operating functions, key caps of said adjacent keys being laterally protected by vertical bars and protruding with respect to insertion direction of said adjacent keys protruding at a distance at least equal to that of said keys.

5. Containing structure that integrates a rear-view driving mirror and an apparatus according to claim 1, further comprising:
a shaped protruding portion on the lower left-hand side profile of the frame defining the rear-view driving mirror, being projected lengthwise which integrates an alphanumeric display, with alongside relative symbolizing.

6. Containing structure that integrates a rear-view driving mirror and an apparatus according to claim 1, further comprising:
a shaped protruding portion on the lower driver side edge, being projected lengthwise and below the frame that integrates the rear-view driving mirror, wherein said shaped protruding portion integrates a monitor also projected lengthwise, and wherein, along the lower border forming a part of the frame defining the rear-view driving mirror, integration of an alphanumeric keyboard is provided with relative function/option keys, placed in such a way as to be aligned.

7. Containing structure that integrates a rear-view driving mirror and an apparatus according to claim 1, further comprising:
a monitor/display being integrated in an area, preferably on the driver side of the rear-view driving mirror.

8. Containing structure that integrates a rear-view driving mirror and an apparatus according to claim 1, further comprising:
a second vertically aligned key on the right-hand side, above a key that operates audio, said second vertically aligned key of the same size as the one underneath and allowing activation of a video function for videocalling.

9. Containing structure that integrates a rear-view driving mirror and an apparatus according to claim 1, further comprising:
an LED being placed on the front side of the containing structure and showing operative status thereof and being integrated along the lower profile of the frame defining the rear-view driving mirror.

10. Containing structure that integrates a rear-view driving mirror and an apparatus according to claim 1, further comprising:
a series of vents allowing an airing of the electronics housed therein at a back side thereof;
a connector enclosed in the back of the protuberance and placed in the lower part; and
a swivel support similar to an integrated pin, allowing spaced support thereof from a windscreen panel of the vehicle.
